(19) United States
(12) Patent Application Publication
(10) Pub. No.: US 2020/0003923 A1
(43) Pub. Date: Jan. 2, 2020

(54) METHOD FOR DETERMINING PHYSICAL CHARACTERISTICS OF A HOMOGENEOUS MEDIUM AND ITS BOUNDARIES

(71) Applicants: Arkady Yurievich SEGAL, Moscow (RU); SCHLUMBERGER TECHNOLOGY CORPORATION, Sugar Land, TX (US)

(72) Inventor: Arkady Yurievich Segal, Moscow (RU)

(21) Appl. No.: 16/466,026

(22) PCT Filed: Dec. 1, 2016
(86) PCT No.: PCT/RU2016/000840

§ 371 Date: Jun. 1, 2019

(51) Int. Cl. G01V 1/50

(52) U.S. Cl. CPC G01V 1/50

(57) ABSTRACT

The harmonic wave, which is oscillation of a physical value along one direction of propagation in a homogeneous medium, is recorded by means of sensors along the direction of propagation of the oscillation at least at five points equally spaced from each other. The output signals of the sensors are converted into the corresponding complex spectral amplitudes corresponding to the frequency decomposition of the output signals. A model of harmonic wave propagation in a homogeneous medium is created, in which for any oscillation frequency the wave is represented as descending and ascending exponentially decaying harmonic waves propagating in opposite directions. The absolute values of the complex spectral amplitudes of the output signals of the sensors at each frequency are used as input data for equations comparing the absolute values of the complex amplitudes with the created model of wave propagation. By solving the obtained equations, the total complex amplitudes of the descending and ascending waves and the complex propagation constant of oscillations at each frequency are determined and the characteristics of the boundaries of the homogeneous medium are determined basing on the ratio of the complex amplitudes of the descending and ascending waves, and the characteristics of the homogeneous medium are determined basing on the phase velocity and attenuation coefficient of the wave.

### FIELD OF THE INVENTION

The invention relates to methods for study of homogeneous media and can be used to determine the physical characteristics of both the media themselves and their boundaries. So, for example, in the case of a well segment that is homogeneous over the length of a well drilled in the ground and filled with fluid, it is possible to determine the sound speed and viscosity of the fluid itself, as well as the productivity coefficient of a formation adjacent to this segment. The invention is also applicable to the study of media, which are a combination of homogeneous components, for example, such fluid-filled wells, which are a complex of constant diameter segments filled with fluids having different properties.

### BACKGROUND

A harmonic wave is an oscillation of a certain frequency, phase and amplitude sinusoidal in time and space. Such excitations usually occur in physical systems described by hyperbolic equations, for example, pressure waves in fluid, P- or S-waves in elastic bodies, electromagnetic waves, etc. In many cases, as a rule, when a wavelength significantly exceeds transverse dimensions of an object, the wave propagation can be represented as one-dimensional. In these cases, each harmonic signal is a superposition of two waves propagating in opposite directions.

Registration of a harmonic wave propagating through a homogeneous one-dimensional segment can provide information about physical characteristics of a segment basing on the phase velocity and wave attenuation coefficient, as well as about boundary conditions at the edges of the segment basing on a reflection coefficient, which is the ratio of the amplitudes of waves propagating in opposite directions. The boundary conditions can provide valuable information about an object located at the boundary, for example, in the event of a pressure wave propagating in a well, the P=ZQ type ratio between pressure P and flow rate Q in the tubing in close proximity to the productive formation can make it possible to judge about the “input function of the reservoir” Z, the zero frequency limit of which is nothing more than a coefficient of formation productivity. The presence of a crack or fluid leakage zone will reveal itself as Z→0 at low frequencies, etc. In seismic surveys, i.e. during propagation of an elastic wave in the rock mass and its reflection from the next layer, the boundary condition is sensitive to the contrast of the impedance of formations, where the impedance Z is proportional to the product of the formation density p and the phase velocity of the wave c, Z˜ρc, which makes it possible to study mechanical characteristics of the formations.

A method for determining harmonic wave characteristics is known from the prior art, as described in U.S. Pat. No. 5,331,604, which permits determination of all quantitative characteristics of the wave. This method comprises recording of acoustic waves by means of sensors located on a logging tool located in the well. The method comprises interpretation of harmonic waves, “discrete frequency waves”, to obtain frequency-dependent reflection coefficients. The computational methods described in this patent rely on interpretation of a set of complex amplitudes, which are coefficients of the spectral decomposition of the signal recorded by the sensors. These methods are quite sensitive to such errors during recording, which lead to inaccuracy in determining the phase of complex amplitudes, in particular, to the errors in synchronization of sensors or in determining the position of sensors.

### SUMMARY OF THE INVENTION

The proposed method for determining physical characteristics of a homogeneous medium and its boundaries is insensitive to arbitrary phase shifts between the sensors that record harmonic waves, and can be used in cases where there is no accurate information about the time shift between sensors or when the time scale of the sensors is subject to drift. In fact, the method proposed in this application uses only absolute values (modules) of complex amplitudes, and does not use phases of complex amplitudes.

The proposed method for determining physical characteristics of a homogeneous medium and its boundaries comprises recording a harmonic wave propagating in a homogeneous medium and representing an oscillation of a physical value along one direction of propagation in the homogeneous medium. Recording comprises recording said physical value by means of sensors along the direction of propagation of the oscillation at least five at points equally spaced from each other. The output signals of the sensors are converted, with the help of a computer system, using a spectral analysis method, into the corresponding complex spectral amplitudes corresponding to the frequency decomposition of the output signals. A model of harmonic wave propagation in the homogeneous medium is created, in which, for any oscillation frequency, the wave is represented as a sum of descending and ascending exponentially decaying harmonic waves propagating in opposite directions, wherein the model depends on the complex amplitudes of the descending and ascending waves and the complex constant of oscillation propagation. With the help of the computer system, the absolute values of the complex spectral amplitudes of the output signals of the sensors are used at each frequency as input data for equations comparing the absolute values of the complex amplitudes with the created model of wave propagation in the homogeneous medium. By solving the obtained equations, the total complex amplitudes of the descending and ascending waves and the complex propagation constant of oscillations at each frequency are determined. The obtained results are used to determine the physical characteristics of the boundaries of the homogeneous medium basing on interpretation of the ratio of the complex amplitudes of the descending and ascending waves, as well as to determine the physical characteristics of the medium itself basing on interpretation of the components of the complex propagation constant, namely, the phase velocity and attenuation coefficient of the wave.

In accordance with one embodiment of the invention, fluctuations of the physical value along the direction of propagation are created in the medium by artificial means.

In accordance with one embodiment of the invention, the homogeneous medium is a segment of a fluid-filled well drilled in the formation, the fluctuations of the physical value are produced by a pump connected to the well or arranged inside it, the physical characteristics of the homogeneous medium are compressibility and viscosity of the fluid filling the well, and the physical characteristics of the boundaries of the homogeneous medium are the coefficient of productivity of the formation adjacent to this segment.

In accordance with another embodiment of the invention, the homogeneous medium is a carrier of electromagnetic waves, and the oscillations of the physical value are produced by an emitter of electromagnetic oscillations.

In accordance with another embodiment of the invention, the conversion of the output signals of the sensors is carried out using a discrete Fourier transformation.

In accordance with one embodiment of the invention, the recording of the physical value at least at five points is carried out simultaneously by means of sensors, each being installed at a corresponding point.

In accordance with another embodiment of the invention, the recording of the physical value at least at five points is carried out sequentially by successively moving at least one sensor in the direction of propagation of fluctuation of the physical value.

### BRIEF DESCRIPTION OF THE DRAWINGS

The invention is illustrated by drawings, where

FIG. 1 is a graph of Pol₈(y) polynomial;

FIG. 2 is a graph of Pol₈(y) polynomial in the presence of an additional sensor;

FIG. 3 shows the general structure of the solutions;

FIG. 4 shows an example implementation of the method.

### DETAILED DESCRIPTION OF THE INVENTION

The following description discloses the essence of the present invention, which permits determination of all the parameters of a harmonic wave, relying only on the absolute values of the complex amplitudes.

For a group of 2N+1 equidistant sensors (N=0, 1, 2, . . . ) we have, for each frequency v:

pₗ≡p(zₗ)=e^{-2πivϵ}^{ₗ}(AG^{-l}+BG^{l})

l=N,N+1, . . . ,1,0,1, . . . N 1,N (1)

where A, B are the complex amplitudes of the descending and ascending waves, G is the complex number, the antenna “transfer function”, pₗ—the values of the measured value at the point number l, zₗ is the coordinate of the point number l. Here, unknown time delays ϵₗ between the starting time of the sensors are also introduced. These equations are valid for describing wave propagation in any time-independent homogeneous medium.

By calculating the absolute values of the complex values pᵢ, the phase dependence is eliminated:

|pₗ|²=|AG^{-l}+BG^{l}|²=(a²g^{-2l}+b²g^{2l}+2ab cos(ϕ−2lζ)) (2)

where:

G≡e^{γΔz}≡ge^{iζ}, g=e^{Re(γ)Δz}, ζ= [symbol] m(γ)Δz (3)

a=|A|, b=|B|, ϕ=arg(A)arg(B)

and Δz—distance between adjacent sensors.

With N=2 there are 5 real equations for 5 real values: a, b, g, γ. Algebraic transformations make it possible to reduce these equations to a single polynomial equation of the 8th order for

y=cos(2ζ). The latter is solved numerically.

The equations have three discrete symmetries:

ζ→ζ+π (3.1)

ϕ→ϕ,ζ→−ζ (3.2)

a→b, b→a, g→1/g, (3.3)

Thus, in all cases, at least 4 solutions are obtained for y from one for y=cos(2ζ):

ζ=±ζ₀, ζ=π±ζ₀, ζ₀=½a cos(y) (4)

Let's describe the procedure for constructing a solution. Determine

$$\begin{matrix}{D}_{0} ≡ {\vert {p}_{0} \vert}^{2} & ( 4.1 ) \\ {D}_{1} ≡ {\vert {p}_{1} \vert}^{2} + {\vert {p}_{- 1} \vert}^{2} & ( 4.2 ) \\ {D}_{2} ≡ {\vert {p}_{2} \vert}^{2} + {\vert {p}_{- 2} \vert}^{2} & ( 4.3 ) \\ {Q}_{1} ≡ {\vert {p}_{1} \vert}^{2} - {\vert {p}_{- 1} \vert}^{2} & ( 4.4 ) \\ {Q}_{2} ≡ {\vert {p}_{2} \vert}^{2} - {\vert {p}_{- 2} \vert}^{2} & ( 4.5 ) \\ {M}_{1} ≡ {D}_{2} + 2 {D}_{0} - 2 {D}_{1} y , {M}_{2} ≡ {D}_{1} - 2 {D}_{0} y , w ( y ) = \frac{{M}_{1}}{{M}_{2}} , & ( 5 )\end{matrix}$$

Then the equation of the 8th order for y is as follows:

P₈(y)=0

P₈(y)=(Q₁M₁−Q₂M₂)²(M₁²−4M₂²)−4(1−y²)×[D₀(2M₂²−D₀(M₁−2yM₂))(M₁−2yM₂)(M₁²−4M₂²)−(Q₂−2Q₁y)²M₂⁴] (6)

Among its roots, one must choose those that meet the conditions

[symbol]

m(y)=0, −1≤y≤1, w(y)≥2 (7)

Since the argument of the transfer function of the antenna ζ is restored only up to discrete symmetries (3.1-2), we obtain four ζ from one y. Additional considerations are required to eliminate discrete uncertainty, for example, if the estimated phase velocity c, is known, one can write

$$ζ \approx \frac{2 π v Δ z}{c} \qquad ( 8 )$$

and choose the one closest to (8) from the four ζ.

Other quantities are expressed via y as follows.

### Calculate g as

$${g}_{\pm }^{2} = \frac{1}{2} ( w \pm \sqrt{{w}^{2} - 4} ) , {g}_{+} {g}_{-} = 1 \qquad ( 9 )$$

Then, a and b are found to be

$$\begin{matrix}{a}_{\pm }^{2} = \frac{1}{2} ( u \pm {v}_{+} ) & ( 10 ) \\ {b}_{\pm }^{2} = \frac{1}{2} ( u ∓ {v}_{+} ) & ( 11 ) \\ {v}_{\pm } = \pm \frac{1}{\sqrt{{w}^{2} - 4}} \frac{{Q}_{2} - 2 {Q}_{1} y}{w - 2 y} & ( 12 )\end{matrix}$$

The last value, cos(ϕ), is equal to

$$cos ( φ ) = \frac{{D}_{0} - u}{2 ab} \qquad ( 13 )$$

and it is not sensitive to the uncertainty of the “±” sign. However, there is another simple uncertainty to obtain ϕ,

ϕ↔−ϕ (14)

There are 8 different solutions for G, since the symmetries “±” with respect to g, which transform g into g−1, exist along with “four ζ from one y”. There are 4 different solutions for A and B due to the “±” symmetry, along with the solution φ↔−φ. With the “±” symmetry the reflection coefficient

$$R ≡ \frac{B}{A} = \frac{b}{a} {e}^{- i φ} \qquad ( 15 )$$

is changed as follows

$$a ↔ b ⇒ R ≡ \frac{B}{A} = \frac{b}{a} {e}^{- i φ} ↔ \frac{a}{b} {e}^{- i φ} = \frac{1}{\overline{R}} \qquad ( 16 )$$

With the φ↔−φ symmetry, we obtain

R↔R̅(17)

Thus, it is possible to determine R with a 4-fold discrete uncertainty. The true value of R can be found with the help of additional considerations, such as calculations ζ by formula (8).

Usually there is more than one root of the equation of the 8th order, which meet the necessary constraints (7):

[symbol]

m(y)=0, −1≤y≤1, w(y)≥2 (18)

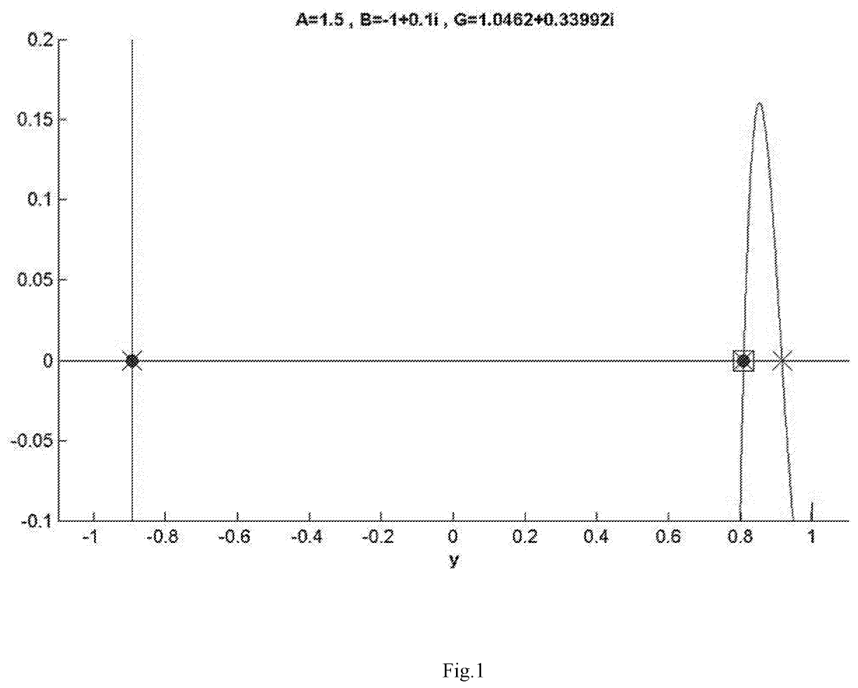

FIG. 1 is a graph of the Pol₈(y) polynomial for A=1.5, B=1+0.1i, G=1.0462+0.33992i. Crosses indicate solutions Pol₈(y)=0. Solid circles indicate a subset of solutions that satisfy the condition w(y)≥2. The true solution is shown in the square.

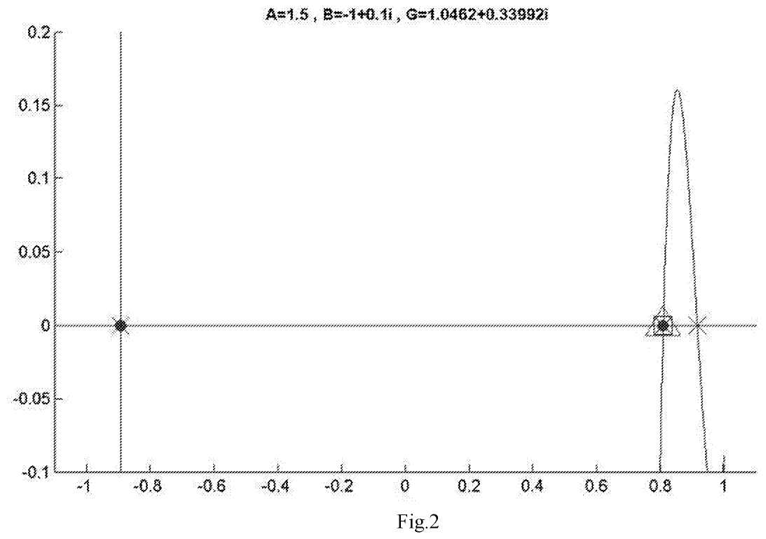

Addition of one more sensor makes it possible to eliminate the above uncertainty and obtain the true root for y. Let's demonstrate this in the following example. FIG. 2 is a graph of the Pol₈(y) polynomial for the same input data as for FIG. 1. Crosses indicate solutions Pol₈(y)=0. Solid circles indicate a subset of solutions that satisfy the condition w(y)≥2. The true solution is shown in the square. The triangle denotes the solution remaining when taking into account the data of the additional sixth sensor.

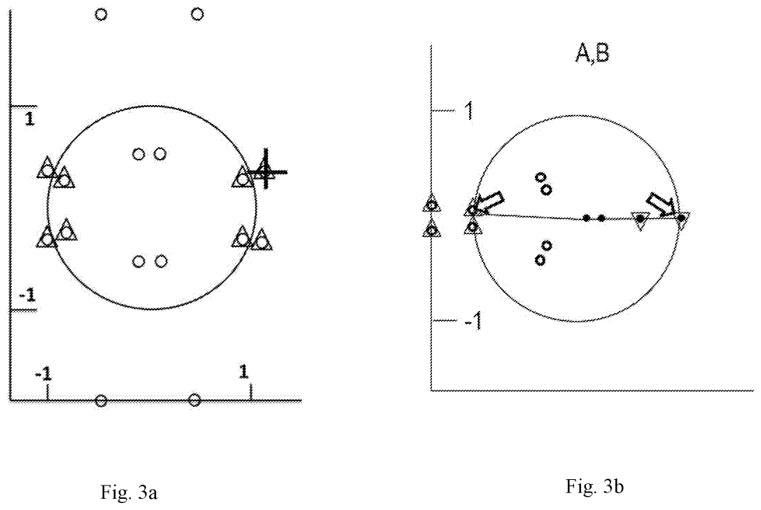

The general structure of the solutions is shown in FIG. 3. FIG. 3a shows the solutions for G, and FIG. 3b shows the solutions for A, B. 3 data sets are shown: 1) G 2) A, B. For each set, the true solution is shown, along with the solutions for methods based on the use of 5 sensors, “5s”, and 6 sensors, “6s”. The graph on the left: G. A cross is a true value, circles are: solutions for 5 sensors, triangles: solutions for 6 sensors. The graph on the right: A, B. An arrow+line on the right: true A, an arrow+line on the right: true B, filled circles: A from the solutions for 5 sensors, empty circles: B from the solutions for 5 sensors, triangles pointing down: A from the solutions for 6 sensors, triangles pointing up: B from solutions for 6 sensors.

Solutions for G are divided into 8-fold sets, each corresponding to the solution P8(y)=0. In all cases there is one solution for method 5s or 6s, which coincides with the true solution, for all values A, B, G. However, all 8 solutions for method 6s will always correspond to the true value y=cos (2γ), therefore method 6s is preferred. The uncertainty of the total time shift associated with a shift in the reference time of the true records by a constant value is used to set

m(A)=0.

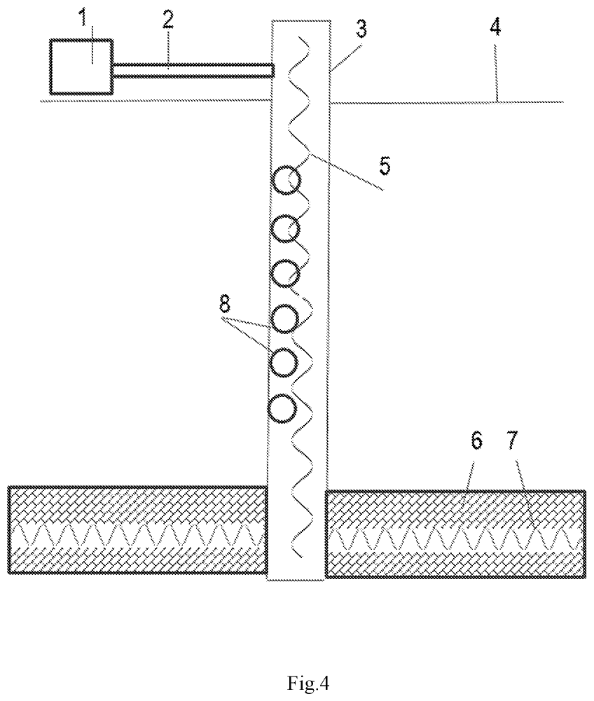

As a practical application of the proposed method, we consider an example given in FIG. 4, where 1 is a pump, 2 is a pipe or pipe system connecting the pump and a well, 3 is a well, 4 is the earth surface, 5 is a harmonic pressure wave profile in the well, at a fixed point in time and on one of the dominant frequencies, 6 is a formation, 7 is a profile of a harmonic pressure wave in the formation, at a fixed point in time and on one of the dominant frequencies, 8 is a system of six equidistant sensors. This example in no way limits the application of the method and is given by way of illustration.

Suppose there is a well 3, drilled in the ground, and filled with fluid, for example, water, or oil. The well 3 may be in communication with at least one permeable formation 6 that intersects it, for example, an oil-bearing formation. Suppose there is a pump 1, installed on surface 4, and either pumping fluid into the formation 6 through the pipe 2, or pumping fluid from the formation 6 through the well 3. As a rule, the pump, regardless of the specifics of its technical implementation, produces periodic fluctuations in the pressure in the fluid filling the well, in addition to the main quasistationary change of pressure in the well. Thus, the well 3 is filled with pressure waves 7, propagating up and down in it. The well is used to place the system 8 of six equidistant pressure sensors, such as high-speed pressure gauges or hydrophones, and periodic pressure fluctuations in the well are recorded that correspond to the pump operation. Sensors can record data in memory, and can transfer them to the surface immediately after recording, if they are connected to a suitable data transmission system, such as, for example, a geophysical cable. In the first case, data analysis involves removing sensors to the surface and uploading data to a computer, in the second case data can be analyzed without removing sensors from the well. Thus, the data set pₗ(t) is obtained, where t is time, and l=1, 2, . . . , N is the sensor number. The data obtained are analyzed by a computer program as follows. A discrete Fourier transformation is performed and the complex amplitudes are obtained Pₗ(vᵢ), where vᵢ is a set of frequencies. The dominant frequencies v_{iD} are determined, for which the modules of complex amplitudes are maximal, equations (1) are solved for each of v_{iD}, where Pₗ(v_{iD}) are used as input data, and complex amplitudes A_{iD}, B_{iD} and the transfer function of the antenna G_{iD} are determined. The G_{iD} contains information about the phase velocity and attenuation coefficient of pressure waves at dominant frequencies and, thus, it can be used to determine the rheology of the fluid, in particular its compressibility and viscosity, while the ratio A_{iD}/B_{iD} can be used to determine the coefficient of productivity of a permeable formation.

In another modification of the method of the present invention, the same situation is considered as described above, however, instead of a set of six sensors, a single sensor is used, which sequentially records pressure at six equally distant depths. The obtained data pₗ(t), l=1 . . . 6 is then used in the same way as in the method described above, while the time shift between the measurements made by one sensor at different depths is insignificant due to the mathematical structure of the method. The only limitation in this case is the condition of stability of the pump operation and the stationarity of all main parameters of the well and the formation for the entire time of data collection.

It is implied that a model of wave propagation in said medium was previously created, in which for each oscillation frequency a wave is represented as descending and ascending exponentially decaying harmonic waves propagating in opposite directions, and the model depends on the complex amplitudes of the descending and ascending waves and on the complex constant of propagation of fluctuations. Since the model depends on a set of geometrical and physical parameters of the medium, and the values characterizing the wave propagation are functions of these parameters and frequencies, it is possible to choose the parameters of the medium so that these values coincide with the measured ones. An example is the propagation of a weak pressure pulse in a rigid pipe filled with fluid of a constant diameter, in this case the physical parameters defining the phase velocity and attenuation coefficient at a certain frequency are density, bulk modulus, viscosity, and diameter of the pipe, while an example of parameters affecting the reflection coefficient is the ratio of diameters of the adjacent pipe sections.

As it is indicated above, the obtained results can be used to determine the physical characteristics of the boundaries of a homogeneous medium basing on the interpretation of the ratio of the complex amplitudes of the descending and ascending waves (reflection coefficient), as well as to determine the physical characteristics of the medium itself basing on the interpretation of the components of the complex propagation constant, namely phase velocity and wave attenuation coefficient. Here is an example.

In the case of waves propagating in a hard pipe of radius r filled with a viscous fluid having density p with the phase velocity of bulk waves c and viscosity η, the following relations are satisfied in the low-frequency approximation

$$γ = i \frac{ω}{c} + \frac{4 η}{ρ c {r}^{2}}$$

Where i is the imaginary unit, ω is the circular frequency, and the reflection coefficient in the zone of the joint of pipes of radii r₁ and r₂

$$R = \frac{{r}_{2}^{2} {r}_{1}^{2}}{{r}_{2}^{2} + {r}_{1}^{2}}$$

Thus, knowing r₁ and measuring y and R by the method described above, one can determine

$$c , \frac{η}{ρ} , \frac{{r}_{2}}{{r}_{1}} .$$

1. A method for determining physical characteristics of a homogeneous medium and its boundaries, comprising:
recording a harmonic wave propagating in a homogeneous medium and representing an oscillation of a physical value along one direction of propagation in the homogeneous medium, wherein recording comprises recording said physical value by means of sensors along the direction of propagation of the oscillation at least five at points equally spaced from each other,
converting the output signals of the sensors, with the help of a computer system, using a spectral analysis method, into the corresponding complex spectral amplitudes corresponding to the frequency decomposition of the output signals,
creating a model of harmonic wave propagation in the homogeneous medium, in which for any oscillation frequency the wave is represented as descending and ascending exponentially decaying harmonic waves propagating in opposite directions, wherein the model depends on the complex amplitudes of the descending and ascending waves and the complex constant of oscillation propagation,
using, with the help of the computer system, the absolute values of the complex spectral amplitudes of the output signals of the sensors at each frequency as input data for equations comparing the absolute values of the complex amplitudes with the created model of wave propagation,
determining, by solving the obtained equations, the total complex amplitudes of the descending and ascending waves and the complex propagation constant of oscillations at each frequency, and
determining the physical characteristics of the boundaries of the homogeneous medium basing on the ratio of the complex amplitudes of the descending and ascending waves, and the physical characteristics of the homogeneous medium basing on the phase velocity and attenuation coefficient of the wave.

2. Method of claim 1, comprising creating fluctuations of the physical value along the direction of propagation in the medium by artificial means.

3. Method of claim 2, wherein the homogeneous medium is a segment of a fluid-filled well drilled in the formation, the fluctuations of the physical value are produced by a pump connected to the well or arranged inside it, the physical characteristics of the homogeneous medium are compressibility and viscosity of the fluid filling the well, and the physical characteristics of the boundaries of the homogeneous medium are the coefficient of productivity of the formation adjacent to this segment.

4. Method of claim 2, wherein the homogeneous medium is a carrier of electromagnetic waves, and the oscillations of the physical value are produced by an emitter of electromagnetic oscillations.

5. Method of claim 1, wherein the conversion of the output signals of the sensors is carried out using a discrete Fourier transformation.

6. Method of claim 1, wherein the recording of said physical value at least at five points is carried out simultaneously by means of sensors, each being installed at a corresponding point.

7. Method of claim 1, wherein the recording of said physical value at least at five points is carried out sequentially by successively moving at least one sensor in the direction of propagation of fluctuation of the physical value.
